(19) United States
(12) Patent Application Publication
(10) Pub. No.: US 2026/0370561 A1
(43) Pub. Date: Nov. 19, 2026

(54) WIRELESS COMMUNICATION SYSTEM AND METHOD FOR DETERMINING AI/ML MODEL DURING UE MOBILITY

(71) Applicant: SHENZHEN TCL NEW TECHNOLOGY CO., LTD., Shenzhen, Guangdong (CN)

(72) Inventor: Miao QU, Shenzhen, Guangdong (CN)

(73) Assignee: SHENZHEN TCL NEW TECHNOLOGY CO., LTD., Shenzhen, Guangdong (CN)

(21) Appl. No.: 19/126,231

(22) PCT Filed: Nov. 4, 2022
(86) PCT No.: PCT/CN2022/130072

§ 371 Date: Apr. 30, 2025

(51) Int. Cl. H04L 41/16; H04L 41/14

(52) U.S. Cl. CPC H04L 41/16; H04L 41/145

(57) ABSTRACT

A method for determining an artificial intelligence (AI)/machine learning (ML) model in a wireless communication system based on information includes receiving the information from a first node and/or a second node by a third node, wherein the information is used for the third node to determining the AI/ML model in the wireless communication system. Further, a method of processing about the AI/ML model by a first node includes the first node receiving a message from a third node and/or a second node, and the first node changing the AI/ML model or not.

### BACKGROUND OF DISCLOSURE

### 1. Field of the Disclosure

The present disclosure relates to the field of wireless communication systems, and more particularly, to a wireless communication system and a method for determining artificial intelligence (AI)/machine learning (ML) model during user equipment (UE) mobility. More specifically, the target is to ensure that an AI/ML model work properly after handover completing. The present disclosure may decrease the latency and guarantee the service continuity for UE mobility in AI/ML based wireless communication system.

### 2. Description of the Related Art

Our society is undergoing a digitization revolution, in the last few years, artificial intelligence (AI) and machine learning (ML) methods are widely used in various industries to advance innovation and increase process efficiency. However, for the network design, with the dramatic increase of both the extraordinary amount of data and network complexity, conventional approaches will not be able to provide swift solutions in many cases. Hence, AI/ML will be an indispensable technology to improve the performance for future wireless communication networks.

Support for integrating AI/ML into the design of cellular network, the NWDAF (network data analytics function) was introduced in Rel.15 and has been enhanced in Rel.16 and Rel.17 in SA2, which insights are mainly applied to 5G core (5GC) networks to enhance their functionality. Meanwhile, Optimized data collection and storage has been specified, together with training and ML model retrieval. In November 2019, 3GPP SA1 TR22.874 has studied the use cases and the potential performance requirements for 5G system (5GS) support of Artificial Intelligence/Machine Learning (AI/ML) model distribution and transfer. While for RAN perspective, a study item about AI/ML enabled RAN in RAN3 Rel.17 has approved. This study TR37.817 was to explore the wireless big data acquisitions and applications for network automation and intelligence, including the definition of use case, and the process and information interaction required by different uses cases. Then, for investigate the potential benefits of AI/ML algorithms for air interface, a new study item was supported in Rel.18 at 3GPP RAN plenary meetings, which is leaded by RAN1. This study involves three uses cases, such as CSI feedback enhancement, beam management and positioning accuracy enhancement, and the related discussion is divided in two parts, common topics and use case specific topics. After twice meetings later, the study for RAN2 perspective is started in October 2022, it mainly focusses on the procedure and signalling based on RANI process and agreements.

Many companies mention that the handover is a factor that led to model selection, in RAN1#110bis meeting, is made an initial agreement for the mechanism of model selection, for UE sided models and two-sided models. More specifically, the decision of model selection can be by network and UE.

Actually, in the AI/ML over air interface wireless communication system, the channel may become worse due to the UE mobility. Consequently, may result in handover happening. When UE move into a new serving gNB, the system can use traditional method and AI/ML-based method in some use cases. If the AI/ML-based method is adopted, in order to ensure the service continuity, trigger model selection is a candidate method. However, the details of model selection for UE mobility are not discussed. Furthermore, since UE moves into a new serving gNB, the AI/ML model and/or its characteristics which used in the old serving gNB may be knew for the serving gNB, during UE mobility, it may involve the model transfer. Besides, considering the large size of AI/ML model will generate signaling overhead, model reconfiguration also seems possible.

Therefore, based on the above discussion, during UE mobility, the method for determining an AI/ML model for new serving gNB should be studied.

### SUMMARY

An object of the present disclosure is to propose a wireless communication system and a method for determining artificial intelligence (AI)/machine learning (ML) model during user equipment (UE) mobility, to provide the methods for determining AI/ML model during UE mobility, which is not discussed in current study and guarantee the service continuity during UE mobility and improve handover performance.

In a first aspect of the present disclosure, a method for determining an artificial intelligence (AI)/machine learning (ML) model in a wireless communication system based on information includes receiving the information from a first node and/or a second node by a third node, wherein the information is used for the third node to determining the AI/ML model in the wireless communication system.

In a second aspect of the present disclosure, a method of processing about the AI/ML model by a first node includes the first node receiving a message from a third node and/or a second node, and the first node changing the AI/ML model or not.

In a third aspect of the present disclosure, a wireless communication system comprises a memory, a transceiver, and a processor coupled to the memory and the transceiver. The processor is configured to perform the above method.

In a fourth aspect of the present disclosure, a non-transitory machine-readable storage medium has stored thereon instructions that, when executed by a computer, cause the computer to perform the above method.

In a fifth aspect of the present disclosure, a chip includes a processor, configured to call and run a computer program stored in a memory, to cause a device in which the chip is installed to execute the above method.

In a sixth aspect of the present disclosure, a computer readable storage medium, in which a computer program is stored, causes a computer to execute the above method.

In a seventh aspect of the present disclosure, a computer program product includes a computer program, and the computer program causes a computer to execute the above method.

In an eighth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of one or more user equipments and a network/gNB of communication in a communication network system according to an embodiment of the present disclosure.

FIG. 2A is a flowchart illustrating a method for determining an artificial intelligence (AI)/machine learning (ML) model in a wireless communication system based on information according to an embodiment of the present disclosure.

FIG. 2B is a flowchart illustrating a method of processing about the AI/ML model by a first node according to an embodiment of the present disclosure.

FIG. 3A is a schematic diagram illustrating an example of locations of AI/ML model functionalities are for one-sided model according to an embodiment of the present disclosure.

FIG. 3B is a schematic diagram illustrating an example of locations of AI/ML model functionalities are for two-sided model according to an embodiment of the present disclosure.

FIG. 4 is a schematic diagram illustrating an example of locations of AI/ML model functionalities for two-sided model according to an embodiment of the present disclosure.

FIG. 5 is a schematic diagram illustrating an example of locations of AI/ML model functionalities for one sided model according to an embodiment of the present disclosure.

FIG. 6 is a schematic diagram illustrating an example of locations of AI/ML model functionalities for one-sided model according to an embodiment of the present disclosure.

FIG. 7 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

FIG. 1 illustrates that, in some embodiments, one or more user equipments (UEs) 10 and a network/gNB 20 for communication in a communication network system 40 according to an embodiment of the present disclosure are provided. The communication network system 40 includes one or more UEs 10 and a network/gNB 20. The one or more UEs 10 may include a memory 12, a transceiver 13, and a processor 11 coupled to the memory 12 and the transceiver 13. The network/gNB 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

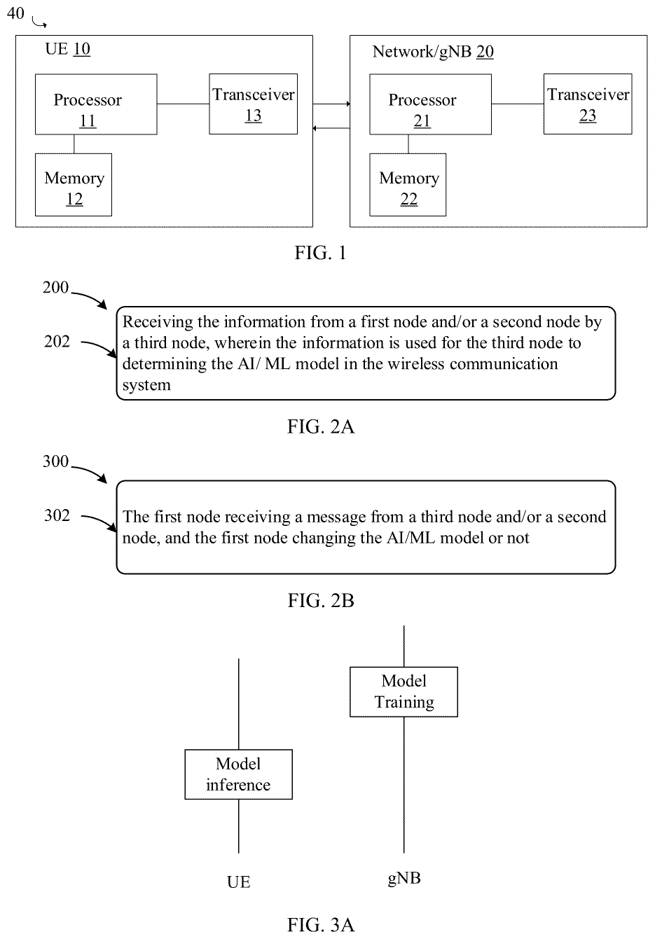

FIG. 2A illustrates a method 200 for determining an artificial intelligence (AI)/machine learning (ML) model in a wireless communication system based on information according to an embodiment of the present disclosure. In some embodiments, the method 200 includes: a block 202, receiving the information from a first node and/or a second node by a third node, wherein the information is used for the third node to determining the AI/ML model in the wireless communication system.

In some embodiments, the information is sent form the first node and/or the second node to the third node and comprises a message including AI/ML model, and/or AI/ML model related assistant information. In some embodiments, AI/ML model is transmitted from the second node to the third node; and/or from the first node to the third node. In some embodiments, the AI/ML model related assistant information contains one of the followings: model ID: model group ID; or parameters and/or structure of AI/ML model. In some embodiments, if the third node receives parameters and/or structure of AI/ML model, and if the third node has model correlation, the third node determines one AI/ML model. In some embodiments, if the third node receives parameters and/or structure of AI/ML model, the third node determines one AI/ML model.

In some embodiments, the third node determines that the AI/ML model by model selection, and/or model reconfiguration, and/or model update. In some embodiments, the model correlation indicates a range for some parameters and/or structure of AI/ML models. In some embodiments, the model correlation is configured by a network, or fixed, or indicated by the second node or the first node. In some embodiments, the model reconfiguration and/or update comprises options as followings: based on the third node decides by itself; or
based on model correlation.

FIG. 2B is a flowchart illustrating a method of processing about the AI/ML model by a first node according to an embodiment of the present disclosure. In some embodiments, the method 300 includes: a block 302, the first node receiving a message from a third node and/or a second node, and the first node changing the AI/ML model or not.

In some embodiments, the message comprises at least one of followings: a first indicator, which indicates whether the AI/ML model changed, and the UE based on the first indicator is able to know if a target gNB uses a new AI/ML model or not; AI/ML model ID, which uniquely identifies the AI/ML model; a second indicator, which indicates that the UE uses the old AI/ML model or use the new AI/ML model. In some embodiments, the first node changes the AI/ML model or not, comprising: if the target gNB sends the second indicator, the UE changes the new AI/ML model change or not based on the second indicator requirement; or if the target gNB does not send the second indicator, but the first node only knows the AI/ML model is changed in the target gNB based on the first indicator, the first node based on itself changes the new AI/ML model or not.

Further, the wireless communication system 40 is configured to perform the above method 200 or the above method 300. The wireless communication system 400 is also configured to perform the method in the following some embodiments.

In some embodiments, the locations of AI/ML model functionalities are for one-side model or two-side mode, and the wireless communication system comprises a base station and a UE. In some embodiments, the AI/ML model functionalities comprise an AI/ML model training function and an AI/ML model inference function. In some embodiments, in the locations of AI/ML model functionalities for one-side model, the AI/ML model training function is deployed in the base station, and the AI/ML model inference function is deployed in the UE; or the AI/ML model training function and the AI/ML model inference function are both deployed in the base station or the UE. In some embodiments, in the locations of AI/ML model functionalities for two-side model, the AI/ML model training function is deployed in the base station or in the UE and the base station, and the AI/ML model inference function is deployed in the UE and the base station.

In some embodiments, a source base station or the UE is able to send a message including AI/ML model related assistant information, and/or transfer an old used AI/ML model to a target base station. In some embodiments, when the source gNB decides to initial the handover procedure for the UE based on related AI/ML model report messages, or the UE is noticed that it is moved to another base station, the source gNB or the UE sends the message including the AI/ML model related assistant information to the target base station, then the target gNB selects an AI/ML model or reconfiguring an AI/ML model based on a received message for the UE to continue working based on the AI/ML operation.

In some embodiments, the received message comprises a model ID for model selection, a model group ID for model selection, a model correlation for model selection, and/or a model reconfiguration. In some embodiments, when the source base station decides to initial the handover procedure for UE based on related AI/ML model report messages, or the UE is noticed that it is moved to another base station, the source base station or the UE sends the AI/ML model to the target gNB, then the target base station uses the old used AI/ML model for the UE to continue working based on the AI/ML operation. In some embodiments, a new message is used for transferring the AI/ML model, and/or an enhancement for legacy message for AI/ML model is used for transferring the AI/ML model. In some embodiments, a partial AI/ML model is sent from the source base station or the UE to the target base station.

In some embodiments, the target gNB sends information about a situation of AI/ML model to the source base station, the source base station forwards the information to the UE, and the UE makes a decision according to the information. In some embodiments, the target gNB sends information about a situation of AI/ML model to the UE, and the UE makes a decision according to the information. In some embodiments, the situation of AI/ML model comprises that: the target base station selects a new AI/ML model, the target base station reconfigures an AI/ML model, or the target base station receives the old used AI/ML model.

In some embodiments, the information comprises at least one of the followings: one indicator which indicates whether the AI/ML model changed, an AI/ML model ID which uniquely identifies the AI/ML model, and one indicator which indicates that the UE uses the old AI/ML model or use the new AI/ML model. In some embodiments, the AI/ML model related assistant information comprises at least one of the followings: a UE ID which uniquely identifies the UE, an AI/ML model ID, which uniquely identifies the AI/ML model, an AI/ML model group ID, which identifies group AI/ML models, a type of AI/ML model, a complexity of AI/ML model, a generalization of AI/ML model, and KPIs of AI/ML model.

This invention is related to wireless communication system, where the AI/ML algorithms are enabled over RAN, the relevant new SID on AI/ML for NR Air Interface of the Rel.18, which is approved in 3GPP RAN plenary meetings 94e in December 2022, and the related discussion is led by RAN1. The study for RAN2 perspective is started in October 2022, it mainly focusses on the procedure and signalling based on RAN1 process. This invention provides the methods for determining AI/ML model during UE mobility. More specifically, the target is that ensure an AI/ML model work properly after handover completing. The provided methods may decrease the latency and guarantee the service continuity for UE mobility in AI/ML based wireless communication system.

Since the UE mobility may result in handover happening, for AI/ML based wireless communication system, the methods for determining an AI/ML model for serving gNB is necessary to support service continuity, which may include the following aspects for different scenarios: model transfer, model selection, and model (re)configuration. In this invention, it may refer to model transfer, model selection, and model reconfiguration. For the following part, use “Source gNB” to present old serving gNB, and use “Target gNB” to present new serving gNB.

In order to make the AI/ML-based method work properly after handover completing because of UE mobility, one important thing is that determining an AI/ML model for the wireless system, this disclosure provides the methods for determining an AI/ML model: Methods of AI/ML model selection, transfer, and/or reconfiguration; and transmission and configuration of AI/ML model related assistant information. The invention effect may provide the methods for determining AI/ML model during UE mobility, which is not discussed in current study and guarantee the service continuity during UE mobility and improve handover performance.

### Embodiment 1

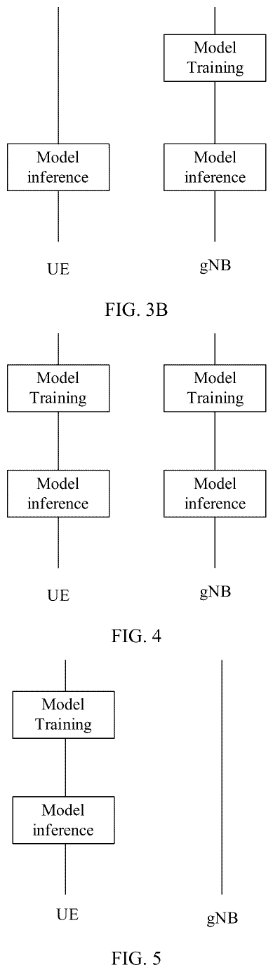

Consider the scenario that: The AI/ML model training function is deployed in gNB, while the AI/ML model inference function sides within the UE and gNB, more specifically, the scenario can be one-sided model and/or two-sided model, the locations of AI/ML model functionalities are depicted as FIG. 3. FIG. 3A and FIG. 3B illustrates locations of AI/ML model functionalities for different scenarios. In details, in FIG. 3A, locations of AI/ML model functionalities are for one-sided model. In FIG. 3B, locations of AI/ML model functionalities are for two-sided model. When a system initials a handover procedure because of UE mobility, in order to maintain service continuity for AI/ML operation in the wireless communication, a source gNB or a UE is able to send a message including AI/ML model related assistant information, and/or transfer the old used AI/ML model to a target gNB. The following methods can be considered.

Method 1: Assistant Information is Sent from Source gNB or UE to Target gNB

In this method 1, when source gNB decides to initial a handover procedure for UE based on related AI/ML model report messages, or UE is noticed that it is moved to another gNB, source gNB or UE may send a message including the AI/ML model related assistant information to target gNB, then target gNB may select an AI/ML model or reconfiguration an AI/ML model based on received message for the UE to continue working based on AI/ML operation. To achieve this, the following alternatives can be considered.

### Alternative 1: Model ID for Model Selection

In some examples, the target gNB receives the message including AI/ML model ID, which is a unify indicator of AI/ML model in global. Then the target gNB according to the AI/ML model ID to search the AI/ML models on its own side. If the target gNB side has the AI/ML model with the same model ID with old used AI/ML model, it means that target gNB side has the same AI/ML model with source gNB and also used to UE side. Then target gNB select this AI/ML model to be used for the UE to continue working based on AI/ML operation.

The received message for target gNB is provided by source gNB, and/or UE. Moreover, the AI/ML model can be trained in other entities, such as third server, other gNB, OAM, OTT and so on. Since AI/ML model training will result in large consume, to avoid repeat training, the trained AI/ML model can be transferred between different entities in some cases. Hence, there may be possible that an AI/ML model is existed in different entities. The model ID can be a relative ID or an absolute ID, whatever, target gNB can based on the model ID to make sure a unique AI/ML model.

### Alternative 2: Model Group ID for Model Selection

In some examples, the target gNB receives the message including AI/ML model group ID, which indicates that these AI/ML models with the same specific function, and/or same characteristics share a same AI/ML model group ID. Then, the target gNB according to the AI/ML model group ID, selects an AI/ML model on its own side. If the target gNB side has the same model group ID of AI/ML model with old used AI/ML model, it means that target gNB side has the AI/ML models with same specific function, and/or same characteristics as the old used AI/ML model which resides source gNB and also used to UE side. Once the AI/ML model which located in target gNB has the same model group ID with old used AI/ML model, it will be regard as candidate AI/ML model. Then, the target gNB selects an AI/ML model among the candidate AI/ML models to be used for the UE to continue working based on AI/ML operation.

Because there may be more than one candidate AI/ML model, the selection rule is described as following: If there is only one candidate AI/ML model, the candidate AI/ML model can be regard as selected AI/ML model directly. If there is more than one candidate AI/ML model, the target gNB can select an AI/ML model among the candidate AI/ML models randomly. The received message for target gNB is provided by source gNB, and/or UE.

### Alternative 3: Model Correlation for Model Selection

In some examples, the target gNB which has a model correlation for model selection in the handover procedure, which indicates a range for some parameters and/or structure of AI/ML model. If the parameters and/or structure of an AI/ML model satisfy the model correlation, it will be regarded as a candidate AI/ML model. More narrowly, the source gNB or UE provides the old used AI/ML model related parameters or structure, such like AI/ML model complexity, generalization, KPI and so on to target gNB, these information are regarded as a baseline/reference point for model correlation. For instance, if the provided layer of the old used AI/ML model is 5, so the said baseline/reference point of model layer is 5 since the model correlation.

Based on baseline/reference float, assume the model correlation floats plus or minus1, hence, the number of model layers falls within the interval of [4, 6], in other words, the AI/ML model which number of layers is 4, 5, 6 can be regarded as candidate AI/ML model by target gNB.

By the way, because of the different nature of the AI/ML related parameters and structure, the model correlation for different parameters and structure can be calculated in a variety of ways, such as adding, subtracting, multiplying, dividing, and other methods, and it may be one or a combination of several.

Moreover, the model correlation can be configured by network, or fixed, or indication by source gNB or UE. Because there may be more than one candidate AI/ML model, the selection rule is described as following: If there is only one candidate AI/ML model, the candidate AI/ML model can be regard as selected AI/ML model directly. If there is more than one candidate AI/ML model, the target gNB can select an AI/ML model among the candidate AI/ML models randomly. The received message for target gNB is provided by source gNB, and/or UE.

### Alternative 4: Model Reconfiguration

In some examples, the source gNB or UE sends the AI/ML model related parameters and/or structure to target gNB, such like AI/ML model complexity, generalization, KPI and so on, which make that target gNB reconfiguration the AI/ML model or change some part of the AI/ML model that resides its own side according to these provided information. For instance, if the provided number of layers is 5, and the AI/ML models reside target gNB may do not satisfy the number of layers, but it has a AI/ML model which number of model layer is 6, hence, the target reconfiguration the number of AI/ML model layer from 6 to 5.

Since the target gNB may hold many AI/ML models, how to determine which AI/ML model should be reconfigured, the options are as followings: Target gNB implementation, it based on target gNB decide by itself. Base on model correlation, set the model correlation for model selection, target gNB select an AI/ML model among the candidate AI/ML models to reconfigure or change it. The details for model range refer to Alternative 3. The received message for target gNB is provided by source gNB, and/or UE.

One or any combination of the above alternatives, which can ensure the UE work properly based AI/ML operation and also guarantee the service continuity during UE mobility.

As mentioned above, in method1, there are several alternatives to achieve the aim during UE mobility. It is noted that all of the alternatives use the assistant information which is included in the message that from source gNB or UE to target gNB. In detail, the message may include at least one of the following assistant information: UE ID, which uniquely identify the UE; AI/ML model ID, which uniquely identify the AI/ML model or relatively identify the AI/ML model; AI/ML model group ID, which identify a group AI/ML models, and the AI/ML models have similar characteristics for same scenario; Type of AI/ML model; which indicates which kind of AI/ML models is; Complexity of AI/ML model, such as FLOPs, size of parameters; Generalization of AI/ML model, which means the capability of AI/ML model can be worked in different use case; KPIs of AI/ML model, such as rate, precision, power consumption, reliability and so on; Format: Format of AI/ML model, which is a format of AI/ML model transfer, it can be privity format, or open format(ONNX), or spec a new format in 3gpp.

Method 2: AI/ML Model is Sent from Source gNB to Target gNB

In this method 2, when a source gNB decides to initial a handover procedure for a UE based on related AI/ML model report messages, or the UE is noticed that it is moved to another gNB, the source gNB or the UE may send the AI/ML model to target gNB directly. Then target gNB uses the old used AI/ML model for the UE to continue working based on AI/ML operation. How to transmit the AI/ML model, the following alternatives can be considered.

### Alternative1: A New Message for Transferring the AI/ML Model

Case1: For transmitted the AI/ML model for source gNB and target gNB, a new Xn message between source gNB and target gNB should be introduced. The Xn message may include at least one of the following assistant information:

UE ID, which uniquely identifies the UE; AI/ML model ID, which uniquely identify the AI/ML model or relatively identify the AI/ML model; AI/ML model group ID, which identify a group AI/ML models, and the AI/ML models have similar characteristics for same scenario; Type of AI/ML model; which indicates which kind of AI/ML models is; Complexity of AI/ML model, such as FLOPs, size of parameters; Generalization of AI/ML model, which means the capability of AI/ML model can be worked in different use case; KPIs of AI/MI model, such as rate, precision, power consumption, reliability and so on; Format: Format of AI/ML model, which is a format of AI/ML model transfer, it can be privity format, or open format(ONNX), or spec a new format in 3gpp.

Case 2: For transmitted the AI/ML model for UE and target gNB, a new RRC message between UE and target gNB should be introduced, meanwhile, it can be transmitted after access is complete. The RRC message may include at least one of the following assistant information: UE ID, which uniquely identify the UE; AI/ML model ID, which uniquely identify the AI/ML model or relatively identify the AI/ML model; AI/ML model group ID, which identify a group AI/ML models, and the AI/ML models have similar characteristics for same scenario; Type of AI/ML model; which indicates which kind of AI/ML models is; Complexity of AI/ML model, such as FLOPs, size of parameters; Generalization of AI/ML model, which means the capability of AI/ML model can be worked in different use case; KPIs of AI/ML model, such as rate, precision, power consumption, reliability and so on; and Format: Format of AI/ML model, which is a format of AI/ML model transfer, it can be privity format, or open format(ONNX), or spec a new format in 3gpp.

### Alternative2: Enhancement for Legacy Message for AI/ML Model

Case 1: For transmitted the AI/ML model for source gNB and target gNB, the legacy Xn message between source gNB and target gNB should be reused. Handover Request as the first Xn message from source gNB to target gNB when source gNB decides to do handover. Hence, the Xn message should introduced some AI/ML related information.

The Handover Request message may include at least one of the following assistant information: AI/ML model ID, which uniquely identify the AI/ML model; AI/ML model group ID, which identify a group AI/ML models, and the AI/ML models have similar characteristics for same scenario; Type of AI/ML model; which indicates which kind of AI/ML models is; Complexity of AI/ML model, such as FLOPs, size of parameters; Generalization of AI/ML model, which means the capability of AI/ML model can be worked in different use case; KPIs of AI/ML model, such as rate, precision, power consumption, reliability and so on; Format of AI/ML model, which is a format of AI/ML model transfer, it can be privity format, or open format(ONNX), or spec a new format in 3gpp.

Case 2: For transmitted the AI/ML model for UE and target gNB, the legacy RRC message between UE and target gNB should be reused. RRC complete as the first is sent from UE to target gNB should be enhanced. Hence, the RRC message should introduced some AI/ML related information.

The RRC complete message may include at least one of the following assistant information: UE ID, which uniquely identify the UE; AI/ML model ID, which uniquely identify the AI/ML model; AI/ML model group ID, which identify a group AI/ML models, and the AI/ML models have similar characteristics for same scenario; Type of AI/ML model; which indicates which kind of AI/ML models is; Complexity of AI/ML model, such as FLOPs, size of parameters; Generalization of AI/ML model, which means the capability of AI/ML model can be worked in different use case; KPIs of AI/ML model, such as rate, precision, power consumption, reliability and so on; Format of AI/ML model, which is a format of AI/ML model transfer, it can be privity format, or open format(ONNX), or spec a new format in 3gpp.

Method 3: Partial AI/ML Model is Sent from Source gNB or UE to Target gNB

In some examples, the source gNB or UE sends the a part of the old used AI/ML model to target gNB, such like backbone, or a part of main AI/ML model structure and parameters, such like layer, or activation function, or optimizer, or AI/ML model complexity, or generalization, or KPI, or type of AI/ML model and so on. Target gNB based on the receive main part AI/ML model to reconfigure or change the AI/ML model.

### Embodiment 2

When the handover happens, based on the above discussion, the target gNB according to the different information, there may be three situations of AI/ML models in target gNB side: (1) The target gNB select a new AI/ML model. (2) The target gNB reconfigure an AI/ML model. (3) The target gNB receive the old used AI/ML model. In the (1) and (2), AI/ML model which will be used in the system is full or partial changed, the AI/ML model is a new AI/ML model to some extent. In the (3), AI/ML model which will be used in the system is not changed, the AI/ML model is the old AI/ML model to some extent.

Subsequently, target gNB will inform UE the situation of AI/ML model, which may notice the UE that AI/ML model at target gNB change or not. Furthermore, if target gNB use a new AI/ML model, it may also ask the UE whether it will change the used AI/ML model; or just inform UE that change the used AI/ML model; or whether use the old AI/ML model or the new AI/ML model, which depends on UE. To achieve this, these alternatives should be considered. Actually, there are two cases for that target gNB will inform to UE. One is that target gNB can inform the UE by source gNB, another is that target gNB notice the UE directly.

### Case 1: Inform the UE by Source gNB

Target gNB will send the information about situation of AI/ML model to source gNB, and source gNB forward these information to UE. UE make a decision according to these information. The information can be at one least of the following:
One indicator, which indicates whether the AI/ML model changed. And UE based on the indicator can know if the target gNB use a new AI/ML model or not; For instance, if the indicator set 0, it means that target gNB use the old AI/ML model, and if the indicator set 1, it means that target gNB use the new AI/ML model;
AI/ML model ID, which uniquely identify the AI/ML model. Base on this element, the UE also can know that whether the AI/ML model change or not, moreover, it also knows the ID of the new AI/ML model; and
One indicator, which indicates that the UE use the old AI/ML model or use the new AI/ML model. For instance, if the indicator set 0, it means the UE can use the old AI/ML model, and if the indicator set 1, it means the UE should use the new AI/ML model. Another instance, if configure the indicator, it means that the UE use the old AI/ML model, vice versa.

Moreover, the above message between source gNB and target gNB may be included in handover command which is in Xn message HANDOVER REQUEST ACKNOWLEDGE, or may be included in new dedicated RRC message which is in Xn message HANDOVER REQUEST ACKNOWLEDGE; or may be included in new dedicated RRC message which is in a new Xn message; the above message between source gNB and UE may be included in RRC Reconfiguration message, or may be included in new dedicated RRC message.

### Case 2: Inform the UE by Target gNB

Target gNB will send the information about situation of AI/ML model to UE directly. More narrowly, the procedure may occur after the UE access to the target gNB. And the UE make a decision according to these information. The information can be at one least of the following:
One indicator, which indicates whether the AI/ML model changed. And UE based on the indicator can know if the target gNB use a new AI/ML model or not; For instance, if the indicator set 0, it means that target gNB use the old AI/ML model, and if the indicator set 1, it means that target gNB use the new AI/ML model;
AI/ML model ID, which uniquely identify the AI/ML model. Base on this element, the UE also can know that whether the AI/ML model change or not, moreover, it also knows the ID of the new AI/ML model;
One indicator, which indicates that the UE use the old AI/ML model or use the new AI/ML model. For instance, if the indicator set 0, it means the UE can use the old AI/ML model, and if the indicator set 1, it means the UE should use the new AI/ML model. Another instance, if configure the indicator, it means that the UE use the old AI/ML model, vice versa.

UE receives the information which is transmitted from target gNB, if the target gNB send the explicit indicator, the UE will be based on the explicit indicator require the new AI/ML model or not; if the gNB does not send the explicit indicator, but only knows the AI/ML model is changed in target gNB, the UE may base on itself to require the new AI/ML model or not. Moreover, the above message between UE and target gNB may be included in RRC Reconfiguration message, or may be included in new dedicated RRC message.

### Embodiment 3

Consider the scenario that: The AI/ML model training function is deployed in gNB side and UE side, while the AI/ML model inference function sides within gNB side and UE side, more specifically, the scenario can be two-sided model for joint training and separate training, the locations of AI/ML model functionalities for two-sided model are depicted as FIG. 4.

### Sub-Embodiment 1

When system initials a handover procedure because of UE mobility, in order to maintain service continuity for AI/ML operation in the wireless communication in embodiment 3, source gNB is able to send a message including AI/ML model related assistant information, and/or transfer the old used AI/ML model which resides source gNB to target gNB. Besides, since there are two parts of training model in different sides (gNB, UE), hence, there is no model transfer between UE and gNB. The following methods can be considered.

Method 1: Assistant Information is Sent from Source gNB to Target gNB

In this method 1, when source gNB decides to initial a handover procedure for UE based on related AI/ML model report messages, source gNB may send a message including the AI/ML model related assistant information to target gNB, then target gNB may select an AI/ML model or reconfiguration an AI/ML model based on received message for the UE to continue working based on AI/ML operation. To achieve this, the following alternatives can be considered:

The alternatives are same as embodiment1-method1, but it is noticed that assistant information is only provided by source gNB, no UE involved.

Method 2: AI/ML Model is Sent from Source gNB to Target gNB

In this method 2, when a source gNB decides to initial a handover procedure for UE based on related AI/ML model report messages, the source gNB may send the AI/ML model to a target gNB directly. Then, the target gNB uses the old used AI/ML model for the UE to continue working based on AI/ML operation. How to transmit the AI/ML model, the following alternatives can be considered. The alternatives are same as embodiment 1-method 2, but it is noticed that assistant information is only provided by the source gNB, no UE is involved, and the AI/ML model is only carried in Xn message.

### Sub-Embodiment 2

Furthermore, When the handover happens, based on the above discussion, the target gNB according to the different information, there may be three situations of AI/ML models in target gNB side: (1) The target gNB select a new AI/ML model. (2) The target gNB reconfigure a AI/ML model. (3) The target gNB receive the old used AI/ML model. In the (1) and (2), AI/ML model which will be used in the system is full or partial changed, the AI/ML model is a new AI/ML model to some extent. In the (3), AI/ML model which will be used in the system is not changed, the AI/ML model is the old AI/ML model to some extent.

Subsequently, target gNB will inform UE the situation of AI/ML model, which may notice the UE that AI/ML model at target gNB change or not. To achieve this, these alternatives should be considered. Actually, there are two cases for that target gNB will inform to UE. One is that target gNB can inform the UE by source gNB, another is that target gNB notice the UE directly.

### Case1: Inform the UE by Source gNB

Target gNB will send the information about situation of AI/ML model to source gNB, and source gNB forward these information to UE. The information can be at one least of the following:
One indicator, which indicates whether the AI/ML model changed. And UE based on the indicator can know if the target gNB use a new AI/ML model or not; For instance, if the indicator set 0, it means that target gNB use the old AI/ML model, and if the indicator set 1, it means that target gNB use the new AI/ML model; and
AI/ML model ID, which uniquely identify the AI/ML model. Base on this element, the UE also can know that whether the AI/ML model change or not, moreover, it also knows the ID of the new AI/ML model.

UE receives the information which is forwarded by source gNB, and knows the AI/ML model is changed or not in target gNB. Then the UE notice the target gNB that it knows the AI/ML model situation or not.

Moreover, the above message between source gNB and target gNB may be included in handover command which is in Xn message HANDOVER REQUEST ACKNOWLEDGE, or may be included in new dedicated RRC message which is in Xn message HANDOVER REQUEST ACKNOWLEDGE; or may be included in new dedicated RRC message which is in a new Xn message; the above message between UE and target gNB may be included in RRC Reconfiguration message, or RRC complete message, or may be included in new dedicated RRC message.

### Case 2: Inform the UE by Target gNB

Target gNB will send the information about situation of AI/ML model to UE directly. More narrowly, the procedure may occur after the UE access to the target gNB. And the UE make a decision according to these information. The information can be at one least of the following:
One indicator, which indicates whether the AI/ML model changed. And UE based on the indicator can know if the target gNB use a new AI/ML model or not; For instance, if the indicator set 0, it means that target gNB use the old AI/ML model, and if the indicator set 1, it means that target gNB use the new AI/ML model; and
AI/ML model ID, which uniquely identify the AI/ML model. Base on this element, the UE also can know that whether the AI/ML model change or not, moreover, it also knows the ID of the new AI/ML model.

UE receives the information which is forwarded by source gNB, and knows the AI/ML model is changed or not in target gNB. Then, the UE notice the target gNB that it knows the AI/ML model situation or not.

Moreover, the above message between UE and target gNB may be included in RRC Reconfiguration message, or may be included in new dedicated RRC message.

### Embodiment 4

Consider the scenario that: The AI/ML model training function is deployed in gNB side, while the AI/ML model inference function also sides within gNB side, more specifically, the scenario can be one sided model, the locations of AI/ML model functionalities are depicted for one sided model as FIG. 5. The methods for determining of AI/ML model and notification of UE are same as embodiment 3.

### Embodiment 5

Consider the scenario that: The AI/ML model training function is deployed in gNB side, while the AI/ML model inference function also sides within gNB side, more specifically, the scenario can be one sided model, the locations of AI/ML model functionalities for one-sided model are depicted as FIG. 6.

In this embodiment, when the UE moves to target gNB, since both model training function and model inference function are located in UE, if the current AI/ML model is able to work properly, there is no need model transfer. However, for other AI/ML functionalities, such as data collection, it may need collect the data from Target gNB. Besides, the AI/ML model may also be refined or reconfigured, the target gNB is one of the entities. Hence, the target gNB may need knows the related assistant information of AI/ML model.

UE will send the message which includes AI/ML model related assistant information to target gNB after UE access to the target gNB, the message may include at least one of the following assistant information:
UE ID, which uniquely identify the UE; AI/ML model ID, which uniquely identify the AI/ML model; AI/ML model group ID, which identify a group AI/ML models, and the AI/ML models have similar characteristics for same scenario; Type of AI/ML model; which indicates which kind of AI/ML models is; Complexity of AI/ML model, such as FLOPs, size of parameters; Generalization of AI/ML model, which means the capability of AI/ML model can be worked in different use case; KPIs of AI/ML model, such as rate, precision, power consumption, reliability and so on; and Format: Format of AI/ML model, which is a format of AI/ML model transfer, it can be privity format, or open format (ONNX), or spec a new format in 3gpp.

Moreover, the above message between UE and target gNB may be included in RRC complete message, or may be included in new dedicated RRC message.

In summary, in order to make the AI/ML-based method work properly after handover completing because of UE mobility, one important thing is that determining an AI/ML model for the wireless system, this disclosure provides the methods for determining an AI/ML model: Methods of AI/ML model selection, transfer, and/or reconfiguration; and transmission and configuration of AI/ML model related assistant information. The invention effect may provide the methods for determining AI/ML model during UE mobility, which is not discussed in current study and guarantee the service continuity during UE mobility and improve handover performance.

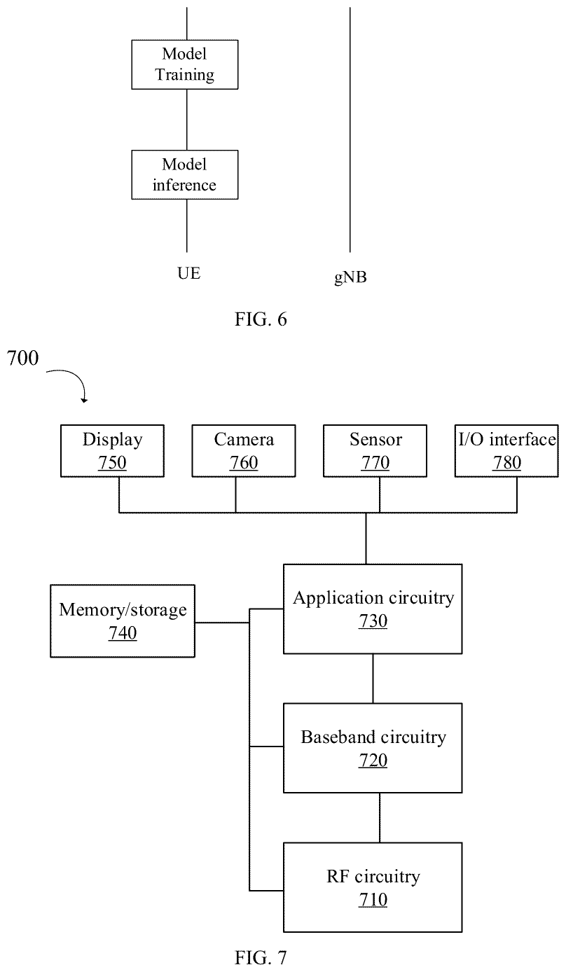

FIG. 7 is a block diagram of an example system 700 for wireless communication according to an embodiment of the present disclosure. Embodiments described herein may be implemented into the system using any suitably configured hardware and/or software. FIG. 7 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method for assisting an artificial intelligence (AI)/machine learning (ML) related operation in a wireless communication system based on information, performed by a third node, comprising:
receiving the information from a first node and/or a second node wherein the information is used for the third node to assist the AI/ML related operation in the wireless communication system.

2. The method for assisting the AI/ML related operation in the wireless communication system based on information according to claim 1, wherein the information is sent form the first node and/or the second node to the third node and comprises a message including AI/ML related operation, and/or AI/ML related assistant information.

3. The method for assisting the AI/ML related operation in the wireless communication system based on information according to claim 2, wherein AI/ML related operation is transmitted from the second node to the third node; and/or from the first node to the third node.

4. The method for assisting the AI/ML related operation in the wireless communication system based on information according to claim 2, wherein the AI/ML related assistant information contains one of the followings:
related operation ID:
related operation group ID; or
parameters and/or structure of AI/ML related operation.

5. The method for assisting the AI/ML related operation in the wireless communication system based on information according to claim 4, wherein if the third node receives parameters and/or structure of AI/ML related operation, and if the third node has related operation correlation, the third node assists one AI/ML related operation.

6. The method for assisting the AI/ML related operation in the wireless communication system based on information according to claim 4, wherein if the third node receives parameters and/or structure of AI/ML related operation, the third node assists one AI/ML related operation.

7. The method for assisting the AI/ML related operation in the wireless communication system based on information according to claim 4, wherein the third node assists that the AI/ML related operation by related operation selection, and/or related operation reconfiguration, and/or related operation update.

8. The method for assisting the AI/ML related operation in the wireless communication system based on information according to claim 5, wherein the related operation correlation indicates a range for some parameters and/or structure of AI/ML related operations.

9. The method for assisting the AI/ML related operation in the wireless communication system based on information according to claim 5, wherein the related operation correlation is configured by a network, or fixed, or indicated by the second node or the first node.

10. The method for assisting the AI/ML related operation in the wireless communication system based on information according to claim 7, wherein the related operation reconfiguration and/or update comprises options as followings:
based on the third node decides by itself; or
based on related operation correlation.

11. A method of processing about the AI/ML related operation by a first node, comprising:
the first node receiving a message from a third node, and/or a second node; and
the first node changing the AI/ML related operation or not.

12. The method of claim 11, wherein the message comprises at least one of followings:
a first indicator, which indicates whether the AI/ML related operation changed, and a user equipment (UE) based on the first indicator is able to know if a target gNB uses a new AI/ML related operation or not;
AI/ML related operation ID, which uniquely identifies the AI/ML related operation;
a second indicator, which indicates that the UE uses the old AI/ML related operation or use the new AI/ML related operation, wherein the first node is the UE, the second node is a gNB, and the third node is the target gNB.

13. The method of claim 12, wherein the first node changes the AI/ML related operation or not, comprising:
if the target gNB sends the second indicator, the UE changes the new AI/ML related operation change or not based on the second indicator requirement; or
if the target gNB does not send the second indicator, but the first node only knows the AI/ML related operation is changed in the target gNB based on the first indicator, the first node based on itself changes the new AI/ML related operation or not.

14. A wireless communication system, comprising:
a memory,
a transceiver; and
a processor coupled to the memory and the transceiver;
wherein the transceiver is configured to receive the information from a first node and/or a second node, wherein the information is used for a third node to assisting the AI/ML related operation in the wireless communication system.

15-19. (canceled)

20. The wireless communication system according to claim 14, wherein the information is sent form the first node and/or the second node to the third node and comprises a message including AI/ML related operation, and/or AI/ML related assistant information.

21. The wireless communication system according to claim 14, wherein AI/ML related operation is transmitted from the second node to the third node; and/or from the first node to the third node.

22. The wireless communication system according to claim 14, wherein the AI/ML related assistant information contains one of the followings:
related operation ID:
related operation group ID; or
parameters and/or structure of AI/ML related operation.

23. The wireless communication system according to claim 22, wherein if the third node receives parameters and/or structure of AI/ML related operation, and if the third node has related operation correlation, the third node assists one AI/ML related operation.

24. The method for assisting the AI/ML related operation in the wireless communication system based on information according to claim 1, wherein the first node is a user equipment (UE), the second node is a gNB, and the third node is a target gNB.

25. The wireless communication system according to claim 14, wherein the first node is a user equipment (UE), the second node is a gNB, and the third node is a target gNB.
